(19) United States
(12) Patent Application Publication
(10) Pub. No.: US 2026/0077638 A1
(43) Pub. Date: Mar. 19, 2026

(54) VEHICLE

(71) Applicant: TOYOTA JIDOSHA KABUSHIKI KAISHA, Toyota-shi (JP)

(72) Inventor: Yugo ICHIDA, Seto-shi (JP)

(73) Assignee: TOYOTA JIDOSHA KABUSHIKI KAISHA, Toyota-shi (JP)

(21) Appl. No.: 19/208,851

(22) Filed: May 15, 2025

(30) Foreign Application Priority Data
Sep. 18, 2024 (JP) 2024-161069

(51) Int. Cl. B60K 1/04

(52) U.S. Cl. CPC B60K 1/04; B60K 2001/0438

(57) ABSTRACT

The vehicle has a ladder-shaped frame including a pair of side members, a first cross member, and a second cross member. The vehicle is provided with an electromechanical integrated unit. The electromechanical integrated unit is disposed between the pair of side members and under the first cross member and the second cross member. The distance between the first cross member and the second cross member in the vehicle length direction is shorter than the length in the vehicle length direction of the electromechanical integrated unit. The second cross member has a first fastening portion. The side member has a second fastening portion. The first fastening portion and the second fastening portion are fastened by a fastening member.

### CROSS-REFERENCE TO RELATED APPLICATION

This application claims priority to Japanese Patent Application No. 2024-161069 filed on Sep. 18, 2024, incorporated herein by reference in its entirety.

### BACKGROUND

### 1. Technical Field

The present disclosure relates to a vehicle.

### 2. Description of Related Art

WO 2022/191264 discloses a vehicle in which a motor is fixed to a ladder-shaped frame including a pair of side members and a plurality of cross members provided between the side members.

### SUMMARY

There is a vehicle in which a motor is disposed on a ladder-shaped frame in which a plurality of cross members are provided between a pair of side members, and a spacing between adjacent cross members is shorter than a length of the motor in the vehicle length direction. In such a vehicle, the motor and the cross member interfere with each other when removing the motor. Therefore, it is difficult to remove the motor from the above vehicle.

In order to address the above issue, an aspect provides a vehicle that drives drive wheels by electric power stored in battery cells inside a battery pack.

The above vehicle includes:
a ladder-shaped frame in which a plurality of cross members extending in a vehicle width direction is provided between a pair of side members spaced apart in the vehicle width direction and extending in a vehicle length direction; and
an electromechanical integrated unit including a motor as a power source that drives the drive wheels and a power control device that supplies electric power to the motor.

The cross members include a first cross member and a second cross member adjacent to the first cross member. The electromechanical integrated unit is disposed between the side members and below the first cross member and the second cross member. A spacing in the vehicle length direction between the first cross member and the second cross member is shorter than a length of the electromechanical integrated unit in the vehicle length direction. In the above vehicle, at least one of the first cross member and the second cross member is joined to an upper surface of the electromechanical integrated unit in a vehicle height direction. At least one of the cross members joined to the upper surface of the electromechanical integrated unit in the vehicle height direction has a first fastening portion at both ends in the vehicle width direction. The side members each have a second fastening portion protruding inward in the vehicle width direction. In the above vehicle, the first fastening portion and the second fastening portion are fastened by a fastening member.

The electromechanical integrated unit is easily removable from the above vehicle, although a spacing in the vehicle length direction between the first cross member and the second cross member is shorter than a length of the electromechanical integrated unit in the vehicle length direction.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram illustrating a vehicle according to an embodiment;

FIG. 2 is a cross-sectional view taken along line 2-2 in FIG. 1;

FIG. 3 is a cross-sectional view taken along line 3-3 in FIG. 1;

FIG. 4 is a cross-sectional view of a first fastening portion and a second fastening portion of a modified example;

FIG. 5 is a schematic diagram illustrating another variation of a vehicle; and

FIG. 6 is a schematic diagram illustrating a vehicle according to another modification example.

### DETAILED DESCRIPTION OF EMBODIMENTS

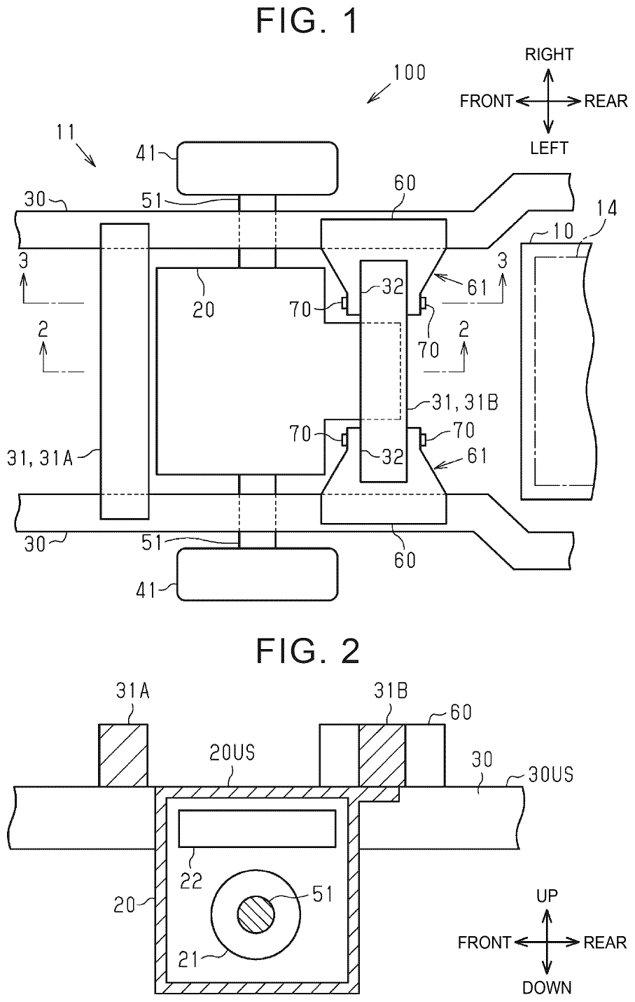

Hereinafter, an embodiment of a vehicle will be described with reference to FIGS. 1 to 3. In the following description, “front,” “rear,” “right,” “left,” “upper,” and “lower” refer to “front,” “rear,” “right,” “left,” “upper,” and “lower” as viewed from a passenger facing the front of the vehicle. The lateral direction coincides with the vehicle width direction.

### Configuration of Vehicle 100

FIG. 1 schematically illustrates an arrangement of devices in a vehicle top view when a vehicle 100 according to an embodiment is viewed from above. As illustrated in FIG. 1, the vehicle 100 includes a ladder-shaped frame 11. The frame 11 includes a pair of side members 30 spaced apart in the vehicle width direction and extending in the vehicle length direction, and a plurality of cross members 31 extending in the vehicle width direction. A portion indicated by a broken line in the side member 30 is located below the plurality of cross members 31 in the vehicle. That is, a plurality of cross members 31 is installed in the two side members 30. As a result, the frame 11 has a ladder shape. The plurality of cross members 31 includes a first cross member 31A and a second cross member 31B adjacent to the first cross member 31A and disposed behind the first cross member 31A.

The vehicle 100 includes an electromechanical integrated unit 20. The configuration of the electromechanical integrated unit 20 will be described later. The electromechanical integrated unit 20 is disposed between the pair of side members 30 and below the first cross member 31A and the second cross member 31B. A portion indicated by a broken line in the electromechanical integrated unit 20 is located below the second cross member 31B. The distance between the first cross member 31A and the second cross member 31B in the vehicle length direction is shorter than the length in the vehicle length direction in the electromechanical integrated unit 20.

FIG. 2 shows a schematic view of a cross-section of the vehicle 100 in FIG. 1 along line 2-2 in FIG. 1. As shown in FIG. 2, in the vehicle side view, the first cross member 31A and the second cross member 31B are disposed above the vehicle with respect to the upper surface 30US of the pair of side members 30. A second cross member 31B is joined to an upper surface 20US of the electromechanical integrated unit 20.

The electromechanical integrated unit 20 is a unit in which the motor 21 and the power control device 22 are integrated. The power control device 22 is disposed so as to overlap the motor 21 above the vehicle. In the vehicle 100, the power control device 22 in the electromechanical integrated unit 20 may not be disposed so as to overlap the vehicle upper side of the motor 21. For example, in the electromechanical integrated unit 20, the power control device 22 may be disposed behind the motor 21 in the vehicle.

The motor 21 is a power source for driving the drive wheels. The plurality of battery cells 14 in the battery pack 10 shown in FIG. 1 store electric power to be supplied to the motor 21. In FIG. 1, a plurality of battery cells 14 laid in the battery pack 10 are collectively indicated by a dashed-dotted line. The vehicle 100 drives the drive wheels by electric power stored in the plurality of battery cells 14. The motor 21 drives the front wheels 41 via the drive shaft 51. That is, the front wheels 41 are drive wheels. A portion indicated by a broken line in the drive shaft 51 is located below the side member 30 in the vehicle.

The power control device 22 illustrated in FIG. 2 is a device that supplies power to the motor 21. The power control device 22 includes an inverter that converts DC power from the plurality of battery cells 14 into AC power and supplies the AC power to the motor 21. The electromechanical integrated unit 20 may include a device other than an inverter as the power control device 22.

### Conclusion of the Side Member 30 and the Second Cross Member 31B

As shown in FIG. 1, each of the pair of side members 30 has a second fastening portion 60 protruding inward in the vehicle width direction. The second cross member 31B joined to the upper surface 20US of the electromechanical integrated unit 20 in the vehicle height direction has first fastening portions 32 at both ends in the vehicle width direction.

The first fastening portion 32 on the right side in the vehicle width direction among the two first fastening portions 32 included in the second cross member 31B and the second fastening portion 60 included in the side member 30 on the right side in the vehicle width direction are fastened by the fastening member 70. The first fastening portion 32 on the left side in the vehicle width direction among the two first fastening portions 32 included in the second cross member 31B and the second fastening portion 60 included in the left side member 30 in the vehicle width direction are fastened by the fastening member 70.

Between the pair of side members 30 in the vehicle top view, the second fastening portion 60 has a tapered portion 61 whose length in the vehicle length direction decreases from the vehicle width direction outer side toward the vehicle width direction inner side.

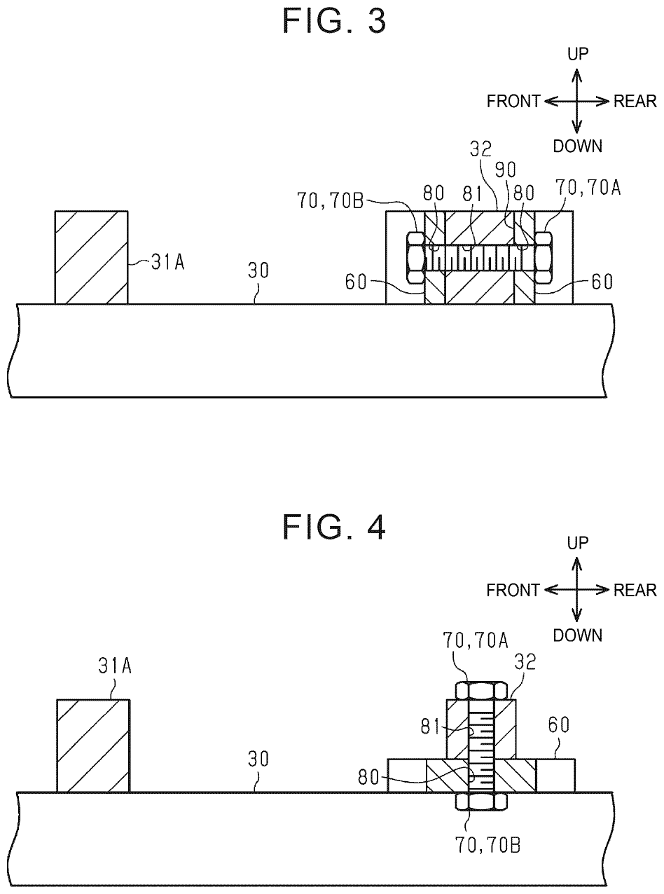

FIG. 3 shows a schematic view of a cross-section of the vehicle 100 in FIG. 1 along line 3-3 through the center of the fastening member 70 in FIG. 3. As shown in FIG. 3, the second fastening portion 60 has a groove portion 90 extending in the vehicle height direction and opening upward and downward in the vehicle. The first fastening portion 32 is connected to the groove portion 90. That is, the first fastening portion 32 is sandwiched from the vehicle front side and the vehicle rear side by the second fastening portion 60.

The first fastening portion 32 is provided with a through hole 81 extending in the horizontal direction. The second fastening portion 60 is also provided with two through holes 80 extending in the horizontal direction. The bolt 70A as the fastening member 70 is inserted into the two through holes 80 and the through hole 81. A nut 70B is screwed to a distal end of the bolt 70A. The first fastening portion 32 and the second fastening portion 60 are fastened by screwing so as to be sandwiched between the head portion of the bolt 70A and the nut 70B. As described above, the first fastening portion 32 and the second fastening portion 60 are fastened by the bolt 70A as the fastening member 70 and the nut 70B.

### Removal Method and Attachment Method of the Electromechanical Integrated Unit 20

Next, a method of removing the electromechanical integrated unit 20 in the vehicle 100 will be described. When the electromechanical integrated unit 20 is removed from the vehicle 100, the drive shaft 51 is first removed from the electromechanical integrated unit 20. Next, the fastening member 70 fastening the first fastening portion 32 and the second fastening portion 60 is removed. Thereafter, the first fastening portion 32 is removed from the groove portion 90 by moving the electromechanical integrated unit 20 upward. In this way, the electromechanical integrated unit 20 and the second cross member 31B are removed from the vehicles 100.

Next, methods of attaching the electromechanical integrated unit 20 and the second cross member 31B to the vehicles 100 from which the electromechanical integrated unit 20 has been removed will be described. The electromechanical integrated unit 20 to which the second cross member 31B is joined is moved from above the vehicle or below the vehicle between the pair of side members 30 and below the first cross member 31A. Thereafter, the first fastening portion 32 of the second cross member 31B is connected to the groove portion 90 provided in the second fastening portion 60. Thereafter, the first fastening portion 32 and the second fastening portion 60 are fastened by the fastening member 70.

### Operation of This Embodiment

In the vehicle 100, the fastening member 70 fastening the first fastening portion 32 and the second fastening portion 60 is removed. Accordingly, the second cross member 31B joined to the upper surface 20US of the electromechanical integrated unit 20 can be removed from the side member 30. Thus, the vehicle 100 can remove the electromechanical integrated unit 20 from the side member 30 together with the second cross member 31B joined to the upper surface 20US of the electromechanical integrated unit 20 in the vehicle height.

### Effect of This Embodiment

(1) In the vehicle 100, the distance in the vehicle length direction between the first cross member 31A and the second cross member 31B is shorter than the length in the vehicle length direction of the electromechanical integrated unit 20, but the electromechanical integrated unit 20 is easily detached.
(2) Between the pair of side members 30 in the vehicle top view, the second fastening portion 60 has a tapered portion 61 whose length in the vehicle length direction decreases from the vehicle width direction outer side toward the vehicle width direction inner side. The side member 30 having the second fastening portion 60 supports a load acting from the electromechanical integrated unit 20 via the second fastening portion 60. The longer the length of the second fastening portion 60 in the vehicle length direction, the larger the range of the side members 30 can support the load acting from the electromechanical integrated unit 20. On the other hand, as the length of the second fastening portion 60 in the vehicle length direction increases, the ratio of the second fastening portion 60 between the pair of side members 30 increases. When the work of removing the electromechanical integrated unit 20 is performed, the ratio of the second fastening portion 60 between the pair of side members 30 should be small. Since the second fastening portion 60 has the tapered portion 61, the vehicle 100 can support a load acting from the electromechanical integrated unit 20 over a wide range of the side member 30. Further, in the vehicle 100, since the second fastening portion 60 has the tapered portion 61, it is possible to secure a space between the pair of side members 30 for performing the work of removing the electromechanical integrated unit 20.
(3) In the vehicle 100, the first fastening portion 32 is provided with a through hole 81 extending in the horizontal direction. In the vehicle 100, the second fastening portion 60 is provided with a through hole 80 extending in the horizontal direction. The first fastening portion 32 and the second fastening portion 60 are fastened by a fastening member 70 inserted through the through hole 80 and the through hole 81. Therefore, the vehicle 100 is easier to see the fastening member 70 from the vehicle upper side and the vehicle lower side than a vehicle in which the first fastening portion 32 and the second fastening portion 60 are provided with through holes extending in the vertical direction and the fastening member is inserted into the through holes extending in the vertical direction. Therefore, the vehicle 100 can easily remove the fastening member 70.
(4) In the vehicle side view, the first cross member 31A and the second cross member 31B are disposed above the vehicle with respect to the upper surface 30US of the pair of side members 30. Therefore, in the vehicle 100, the electromechanical integrated unit 20 and the side member 30 overlap each other in the vehicle side view. Thus, the vehicle 100 can protect the electromechanical integrated unit 20 from an impact from the vehicle left-right direction by the side member 30.

### Example of Change

The present embodiment can be modified as follows. The present embodiment and the following modifications can be implemented in combination with each other within a technically consistent range.

The through hole 81 provided in the first fastening portion 32 and the through hole 80 provided in the second fastening portion 60 in the vehicle 100 may not extend in the horizontal direction. For example, as shown in FIG. 4, the through hole 81 provided in the first fastening portion 32 and the through hole 80 provided in the second fastening portion 60 in the vehicle 100 may extend in the vertical direction. In this modification, the first fastening portion 32 and the second fastening portion 60 are fastened vertically by the bolt 70A as the fastening member 70 and the nut 70B.

If the first fastening portion 32 and the second fastening portion 60 are fastened, the second fastening portion 60 may not have the groove portion 90. For example, the first fastening portion 32 and the second fastening portion 60 may be fastened by the fastening member 70 in a state in which the first fastening portion 32 and the second fastening portion 60 are arranged in this order from the front of the vehicle.

If the first fastening portion 32 and the second fastening portion 60 are fastened, the plurality of cross members 31 may be disposed below the upper surface 30US of the pair of side members 30. For example, the first cross member 31A and the second cross member 31B may be disposed below the upper surface 30US of the pair of side members 30.

At least one of the first cross member 31A and the second cross member 31B may be joined to the upper surface 20US of the electromechanical integrated unit 20 included in the vehicle 100 in the vehicle height direction. For example, the first cross member 31A may be joined to the upper surface 20US of the electromechanical integrated unit 20. For example, the first cross member 31A and the second cross member 31B may be joined together on the upper surface 20US of the electromechanical integrated unit 20.

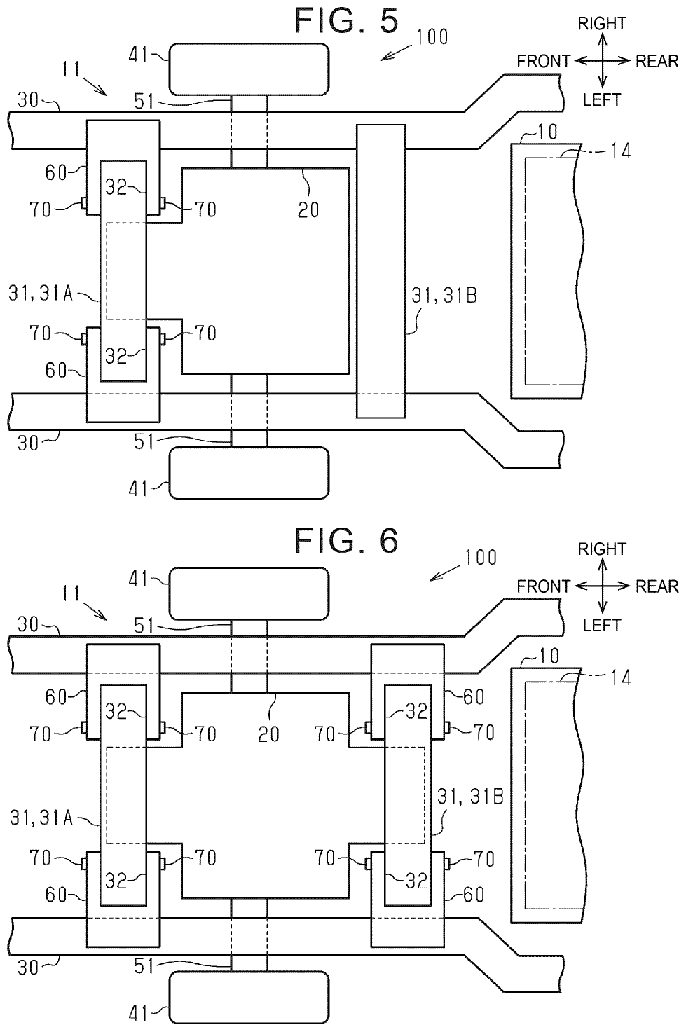

Referring to FIG. 5, a situation will be described in which only the first cross member 31A is joined to the upper surface 20US of the electromechanical integrated unit 20 in the vehicle height orientation, among the first cross member 31A and the second cross member 31B. As shown in FIG. 5, the first cross member 31A has first fastening portions 32 at both ends thereof. Further, the first fastening portion 32 of the first cross member 31A is fastened to the second fastening portion 60 of the side member 30 by the fastening member 70. In the vehicle 100, the fastening member 70 fastening the first fastening portion 32 and the second fastening portion 60 is removed. Accordingly, the first cross member 31A joined to the upper surface 20US of the electromechanical integrated unit 20 can be removed from the side member 30. Thus, the vehicle 100 can remove the electromechanical integrated unit 20 from the side member 30 together with the first cross member 31A joined to the upper surface 20US of the electromechanical integrated unit 20 in the vehicle height. Therefore, the vehicle 100 according to the modified example can obtain the same effects as those of the above-described embodiment. Incidentally, separately from the first cross member 31A, the cross member 31 which does not have the first fastening portion 32 at both ends, when the upper surface 20US in the vehicle height of the electromechanical integrated unit 20 is joined, the joint between the cross member 31 and the upper surface 20US may be eliminated. For example, when the cross member 31 having no first fastening portion 32 at both ends and the upper surface 20US of the electromechanical integrated unit 20 in the vehicle height are fastened by the fastening member, the fastening member may be removed.

Referring to FIG. 6, the first cross member 31A and the second cross member 31B are joined together on the upper surface 20US of the electromechanical integrated unit 20 in the vehicle height direction. As shown in FIG. 6, the first cross member 31A and the second cross member 31B each have a first fastening portion 32 at both ends thereof. Each of the pair of side members 30 has two second fastening portions 60 protruding inward in the vehicle width direction. The first fastening portion 32 of the first cross member 31A is fastened to the second fastening portion 60 of the side member 30 by the fastening member 70. The first fastening portion 32 of the second cross member 31B is fastened to the second fastening portion 60 of the side member 30 by the fastening member 70. The vehicle 100 can remove the first cross member 31A and the second cross member 31B from the side member 30 by removing all the fastening members 70 that fasten the first fastening portion 32 and the second fastening portion 60. Thus, the vehicle 100 can remove the electromechanical integrated unit 20 from the side member 30 together with the first cross member 31A and the second cross member 31B joined to the upper surface 20US of the electromechanical integrated unit 20 in the vehicle height. Therefore, the vehicle 100 according to the modified example can obtain the same effects as those of the above-described embodiment.

The second fastening portion 60 may not have the tapered portion 61. That is, as shown in FIGS. 5 and 6, the length of the second fastening portion 60 in the vehicle 100 in the vehicle length direction may be the same length from the vehicle width direction outer side to the vehicle width direction inner side.

What is claimed is:

1. A vehicle that drives drive wheels by electric power stored in battery cells inside a battery pack, comprising:
a ladder-shaped frame in which a plurality of cross members extending in a vehicle width direction is provided between a pair of side members spaced apart in the vehicle width direction and extending in a vehicle length direction; and
an electromechanical integrated unit including a motor as a power source that drives the drive wheels and a power control device that supplies electric power to the motor, wherein:
the cross members include a first cross member and a second cross member adjacent to the first cross member;
the electromechanical integrated unit is disposed between the side members and below the first cross member and the second cross member, and a spacing in the vehicle length direction between the first cross member and the second cross member is shorter than a length of the electromechanical integrated unit in the vehicle length direction;
at least one of the first cross member and the second cross member is joined to an upper surface of the electromechanical integrated unit in a vehicle height direction;
at least one of the cross members joined to the upper surface of the electromechanical integrated unit in the vehicle height direction has a first fastening portion at both ends in the vehicle width direction;
the side members each have a second fastening portion protruding inward in the vehicle width direction; and
the first fastening portion and the second fastening portion are fastened by a fastening member.

2. The vehicle according to claim 1, wherein the second fastening portion has a tapered portion whose length in the vehicle length direction decreases from an outer side in the vehicle width direction toward an inner side in the vehicle width direction between the side members in a top view of the vehicle.

3. The vehicle according to claim 1, wherein:
the first fastening portion and the second fastening portion are provided with a through hole extending in a horizontal direction; and
the first fastening portion and the second fastening portion are fastened by the fastening member inserted through the through hole.

4. The vehicle according to claim 1, wherein the first cross member and the second cross member are disposed above an upper surface of the side members in a side view of the vehicle.
